(19) United States
(12) Patent Application Publication
(10) Pub. No.: US 2024/0274966 A1
(43) Pub. Date: Aug. 15, 2024

(54) GANG VENT SYSTEMS, ASSEMBLIES AND METHODS

(71) Applicant: Electric Power Systems, Inc., North Logan, UT (US)

(72) Inventors: Wyatt Brown, Richmond, UT (US); Cory Newman, Providence, UT (US)

(73) Assignee: Electric Power Systems, Inc., North Logan, UT (US)

(21) Appl. No.: 18/570,276

(22) PCT Filed: Jun. 27, 2022
(86) PCT No.: PCT/US2022/035150

§ 371 Date: Dec. 14, 2023

Related U.S. Application Data
(60) Provisional application No. 63/216,488, filed on Jun. 29, 2021.

(51) Int. Cl. H01M 50/342

(52) U.S. Cl. CPC H01M 50/342; H01M 2200/20

(57) ABSTRACT

A gang vent system may comprise: a common vent defining a fluid conduit; and a plurality of valve assemblies disposed in the common vent, each valve in the plurality of valve assemblies configured to fluidly seal the fluid conduit from an internal cavity of a housing of a battery module in the battery system during normal operation of the battery system and define a closed position, each valve assembly in the plurality of valve assemblies biased into the closed position.

### FIELD OF INVENTION

The present disclosure generally relates to apparatus, systems and methods for providing gang vent systems, assemblies and methods for battery modules.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected cell-brick assemblies. These cell-brick assemblies may, in turn, include a parallel, series, or combination of both, collection of electrochemical or electrostatic cells hereafter referred to collectively as “cells”, that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Such cells are mass produced, driven by an ever-increasing consumer market that demands low cost rechargeable energy for portable electronics.

Custom battery solutions may be expensive for a respective customer. Custom battery solutions may include longer lead times due to the customization desired by the customer. Custom battery solutions may be engineering intensive to meet desired characteristics by a customer.

### SUMMARY OF THE INVENTION

A gang vent system for a battery system is disclosed herein. The gang vent system may comprise: a common vent defining a fluid conduit; and a plurality of valve assemblies disposed in the common vent, each valve in the plurality of valve assemblies configured to fluidly seal the fluid conduit from an internal cavity of a housing of a battery module in the battery system during normal operation of the battery system and define a closed position, each valve assembly in the plurality of valve assemblies biased into the closed position.

In various embodiments, the common vent comprises a vent outlet. A valve assembly in the plurality of valve assemblies may be configured to open in response to a cell in the battery module entering thermal runaway. In various embodiments, a remainder of valve assemblies in the plurality of valve assemblies are configured to maintain a seal while gases are exhausted through the valve assembly, the common vent, and the vent outlet. The gang vent system may further comprise a plurality of battery modules, each battery module in the plurality of battery modules comprising a vent port and a plurality of cells disposed in the internal cavity, wherein the vent port is sealed by a respective valve assembly in the plurality of valve assemblies during operation of the battery system. In various embodiments, each valve assembly in the plurality of valve assemblies comprises a bracket pivotably coupled to the common vent, a biasing mechanism, each valve assembly in the plurality of valve assemblies configured to transition in steps in a steady and irreversible manner. Each valve assembly in the plurality of valve assemblies may comprise a mounting bracket coupled to a battery module in a plurality of battery modules, the bracket pivotably coupled to the mounting bracket. Each valve in the plurality of valve assemblies may comprise a ratcheting mechanism including a gear and a pawl. The gear of the ratcheting mechanism may be disposed on a flange of the bracket, and the pawl of the ratcheting mechanism may be coupled to the mounting bracket.

A battery system is disclosed herein. The battery system may comprise: a first battery module having a first plurality of cells disposed in a first internal cavity of a first housing, the first housing defining a first vent port: a second battery module having a second plurality of cells disposed in a second internal cavity of a second housing, the second housing defining a second vent port: a third battery module having a third plurality of cells disposed in a third internal cavity of a third housing, the third housing defining a third vent port, wherein the first battery module, the second battery module, and the third battery module are in electrical communication: a first valve assembly configured to seal the first vent port during normal operation of the battery system: a second valve assembly configured to seal the second vent port during normal operation of the battery system: a third valve assembly configured to seal the third vent port during normal operation of the battery system; and a common vent having the first valve assembly, the second valve assembly, and the third valve assembly disposed therein.

In various embodiments, the first valve assembly is configured open in response to a cell in the first plurality of cells entering thermal runaway and creating a pressure to open the first valve assembly. The second valve assembly and the third valve assembly may be configured to isolate an exhaust flow from the second internal cavity and the third internal cavity, and wherein the exhaust flow travels from the first internal cavity through the common vent and out an exhaust outlet. The first valve assembly, the second valve assembly, and the third valve assembly may each be configured to transition in steps in a steady and irreversible manner. The first valve assembly, the second valve assembly, and the third valve assembly may each comprise a bracket, a biasing mechanism, and a ratcheting mechanism, and the ratcheting mechanism may comprise a gear and a pawl. The gear may be disposed on a flange of the bracket and the pawl interfaces with the gear.

A method of gang venting a battery system is disclosed herein. The method may comprise: opening a valve assembly in a plurality of valve assemblies from a closed position to an open position in response to building pressure in an internal cavity of a first battery module, the internal cavity being fluidly coupled to a common vent in response to opening the valve assembly: exhausting gases from the internal cavity and through the common vent; and maintaining a seal between a remainder of valve assemblies in the plurality of valve assemblies during the exhausting gases from the internal cavity.

In various embodiments, the seal is maintained between a fluid conduit defined by the common vent and each internal cavity of each battery module in a plurality of battery modules, the plurality of battery modules excluding the first battery module. Opening the valve assembly may further comprise transitioning the valve assembly from a first position to a second position in response to experiencing a first pressure. Opening the valve assembly may further comprise transitioning the valve assembly from the second position to a third position in response to experiencing a second pressure, the second pressure being greater than the first pressure. In various embodiments, the second position has a greater opening volume compared to the first position.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and where:

FIG. 1 illustrates a perspective view of a battery system, in accordance with various embodiments.

FIG. 2A illustrates a perspective view of a battery module for a battery system, in accordance with various embodiments.

FIG. 2B illustrates an exploded perspective view of a battery module for a battery system, in accordance with various embodiments.

FIG. 3A illustrates a portion of a gang vent system for a battery system, in accordance with various embodiments.

FIG. 3B illustrates a portion of a gang vent system for a battery system, in accordance with various embodiments.

FIG. 4 illustrates an exploded perspective view of a valve assembly for a battery module for a battery system, in accordance with various embodiments.

FIGS. 5A-5C illustrate a valve assembly for a battery module in during opening process for a battery system, in accordance with various embodiments.

FIG. 6 illustrates a perspective view of a portion of a gang vent system for a battery system, in accordance with various embodiments.

FIG. 7 illustrates a cross-sectional view of a portion of a gang vent system for a battery system, in accordance with various embodiments.

FIG. 8 illustrates a perspective view of a battery system, in accordance with various embodiments.

FIG. 9 illustrates a schematic view of an electrically powered aircraft with a battery system, in accordance with various embodiments.

### DETAILED DESCRIPTION

The following description is of various example embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments, without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent example functional relationships and/or physical couplings between various elements. It should be noted that many alternative or additional functional relationships or physical connections may be present in a modular structure.

In an example embodiment, a gang vent system for a battery system includes a plurality of interconnected battery modules (ICBMs), each interconnected battery module including a respective valve. The valve for each ICBM is configured to vent foreign object debris (FOD), thermal runaway ejecta, or gases from the ICBM. Similarly, the valve for each ICBM is configured to seal each ICBM from FOD, thermal runaway ejecta, or gases from adjacent ICBMs in the plurality of ICBMs. In various embodiments, the valve includes a valve configured to open in an irreversible manner. Although described herein as opening in an irreversible manner, the present disclosure is not limited in this regard. For example, the valve may be configured to open due to increase pressure from FOD or gases and close once the pressure subsides, in accordance with various embodiments.

In various embodiments, the gang vent system includes a common vent. In various embodiments, the common vent is configured to be in fluid communication with an internal cavity of an ICBM in thermal runaway and fluidly isolated from an internal cavity of ICBMs that are not in thermal runaway. In this regard, FOD, ejecta, and/or gases from the ICBM in thermal runaway may be vented out the common vent while each ICBM not in thermal runaway may be at least partially thermally isolated from the FOD, thermal runaway ejecta, and/or gases. In this regard, the gang vent system disclosed herein may be configured to prevent propagation of a thermal runaway event from one ICBM to another ICBM in the plurality of ICMBs and/or contain a thermal runaway event to a single ICMB in the plurality of ICBMs.

In various embodiments, a venting system as disclosed herein allows multiple ICBMs to be ganged into one structure to reduce space and weight of a battery system. In various embodiments, a venting system disclosed herein may facilitate controlled venting (i.e., increased exit cross-sectional area for increased pressure and decreased exit cross-sectional area for decreased pressure). In various embodiments, the valve for each ICBM may be configured to create near zero back pressure in a thermal runaway event and/or provide greater venting control during a thermal runaway event (e.g., via a ratcheting mechanism, or the like).

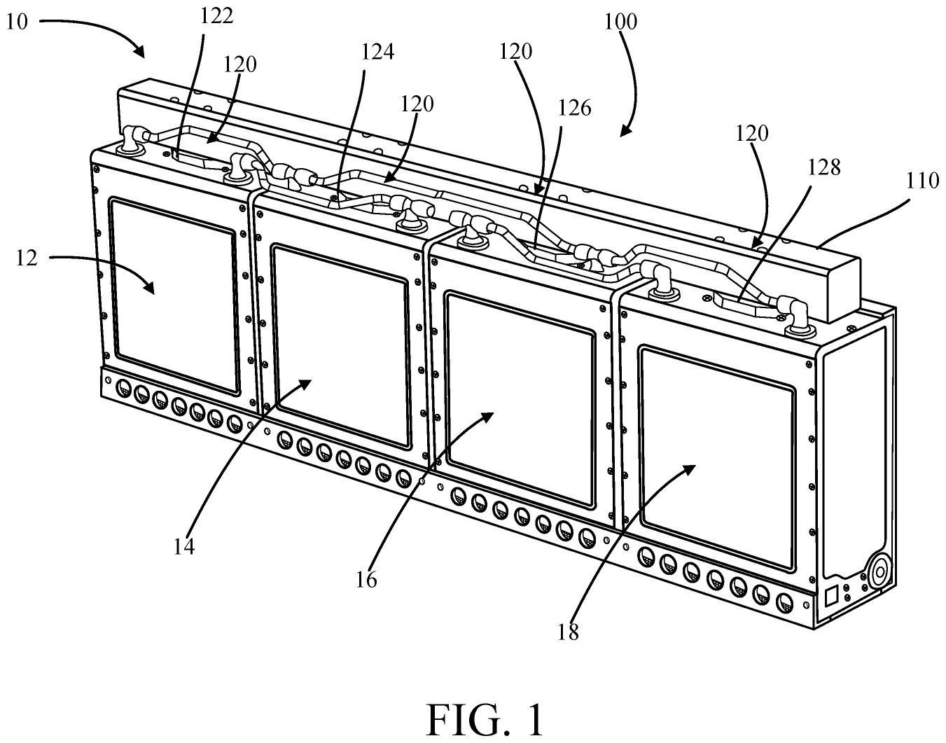

Referring now to FIG. 1, a perspective view of a portion of an interconnected battery system 10 having a gang vent system 100 is illustrated, in accordance with various embodiments. In various embodiments, the interconnected battery system 10 includes a plurality of interconnected battery modules (e.g., interconnected battery modules 12, 14, 16, 18). In various embodiments, each interconnected battery module (e.g., ICBMs 12, 14, 16, 18) includes a plurality of cells disposed therein. The plurality of cells may be cylindrical cells, prismatic cells, pouch cells, or any other cell. In various embodiments, the plurality of cells are a plurality of pouch cells.

In an example embodiment, an ICBM (e.g., ICBMs 12, 14, 16, 18) as disclosed herein may comprise a nominal voltage of approximately 7 volts, a capacity of approximately 50 ampere-hours, an energy output of approximately 0.36 kWh, or the like. Although an example ICBM may have these specifications, an interconnected battery module of any specification is within the scope of this disclosure. In an example embodiment, a 1,000 volt interconnected battery module system may be created by interconnecting one-hundred and thirty-six ICBMs in series as disclosed herein. In various embodiments, by having each ICBM isolated and discrete from the remaining ICBMs, a thermal runaway event may be limited to a single ICBM where the thermal runaway event occurs. In this regard, in accordance with various embodiments, an ICBM, as disclosed herein, may be configured to contain a thermal runaway event of a cell disposed in the ICBM without affecting any cell in any of the remaining ICBMs.

In various embodiments, the interconnected battery system 10 comprises a gang vent system 100 a common vent 110 and a plurality of fluid outlets 120. In various embodiments, the plurality of fluid outlets 120 are configured for fluid communication with the common vent 110 during a thermal runaway event. For example, during normal operation of interconnected battery system 10, the plurality of fluid outlets 120 (e.g., fluid outlets 122, 124, 126, 128) are sealed and configured to fluidly isolate a respective internal cavity of each ICBM and the common vent 110 (e.g., fluid outlet 122 fluidly isolates an internal cavity of ICBM 12 from the common vent 110, etc.), as described further herein. In this regard, weight and cost of the interconnected battery system 10 may be reduced by having the common vent 110 routing that is common between all ICBMs (e.g., ICBMs 12, 14, 16, 18).

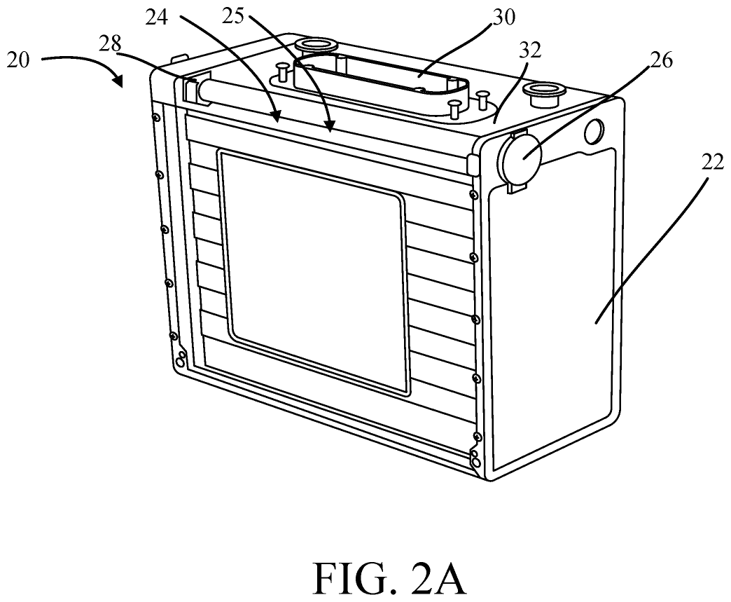

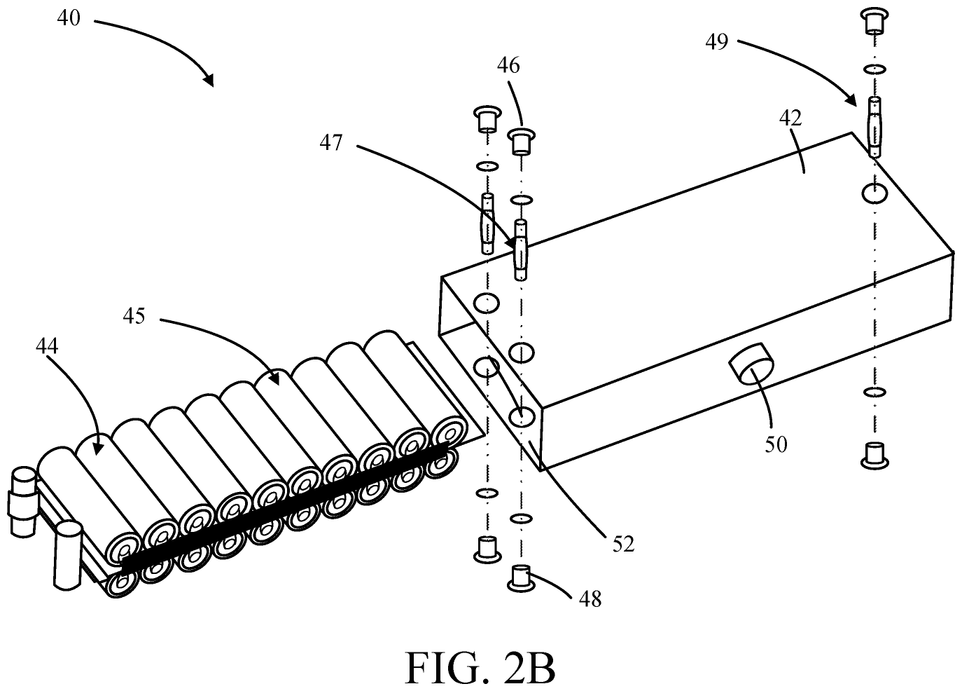

Referring now to FIG. 2A, a perspective view of an ICBM 20 illustrated with a translucent housing is illustrated, in accordance with various embodiments. In various embodiments the ICBM 20 includes a housing 22 and a plurality of cells 24 disposed in the housing 22. In various embodiments, the plurality of cells 24 are a plurality of pouch cells 25. In various embodiments, the ICBM 20 includes a positive terminal 26 disposed on a first side of the housing 22 and a negative terminal 28 disposed on a second side of the housing 22.

In various embodiments, the positive terminal 26 is configured to electrically and physically couple to a negative terminal (e.g., negative terminal 28) of an adjacent ICBM in an interconnected battery system (e.g., interconnected battery system 10 from FIG. 1). Similarly, the negative terminal 28 is configured to electrically and physically couple to a positive terminal (e.g., positive terminal 26) of an adjacent ICBM in an interconnected battery system (e.g., interconnected battery system 10 from FIG. 1). In this regard, the ICBMs of interconnected battery system 10 may be configured for electrical and physical coupling in series electrically and may be configured with an additional component to create a parallel electrical connection, in accordance with various embodiments. The present disclosure is not limited in this regard. For example, the interconnected battery system may be configured to couple adjacent ICBMs in parallel as a default configuration instead of in series as a default configuration and still be within the scope of this disclosure.

In various embodiments, the housing 22 includes a vent port 30. In various embodiments, the vent port 30 is a fluid outlet in the plurality of fluid outlets 120 in an interconnected battery system 10 from FIG. 1. In various embodiments, the vent port 30 is disposed on a top surface of the housing. The vent port 30 is in fluid communication with an internal cavity 32 of the housing 22. The plurality of cells 24 are also disposed in the internal cavity 32. In this regard, any ejecta, gases, or FOD from a thermal runaway event may be configured to be expelled out the vent port 30 and into a common vent (e.g., common vent 110 from FIG. 1) and out of the interconnected battery system (e.g., interconnected battery system 10 from FIG. 1).

Referring now to FIG. 2B, a perspective exploded view of an ICBM 40 is illustrated, in accordance with various embodiments. In various embodiments, the ICBM 40 includes a housing 42 and a plurality of cells 44. In various embodiments, the plurality of cells 44 are a plurality of cylindrical cells 45. In various embodiments, the ICBM 40 includes an electrical connector assembly 47 having a positive terminal 46 and a negative terminal 48. In various embodiments, the positive terminal 46 and the negative terminal 48 may be configured in a manner similar to the positive terminal 26 and the negative terminal 28 from FIG. 2A (i.e., configured to physically and electrically couple to an adjacent electrical connector assembly to form an interconnected battery system 10 from FIG. 1).

In various embodiments, the ICBM 40 comprises a vent port 50 disposed in the housing 42. In various embodiments, the vent port 50 is a fluid outlet in the plurality of fluid outlets 120 of an interconnected battery system 10 from FIG. 1. The vent port 50 is in fluid communication with an internal cavity 52 of the housing 42. The internal cavity 52 is configured to house the plurality of cells 44. The plurality of cells 44 may form a cell-brick assembly, in accordance with various embodiments.

Although illustrated as including pouch cells 25 in FIG. 2A and cylindrical cells 45 in FIG. 2B, any electrical cell is within the scope of this disclosure. For example, button cells and prismatic cells are also within the scope of this disclosure.

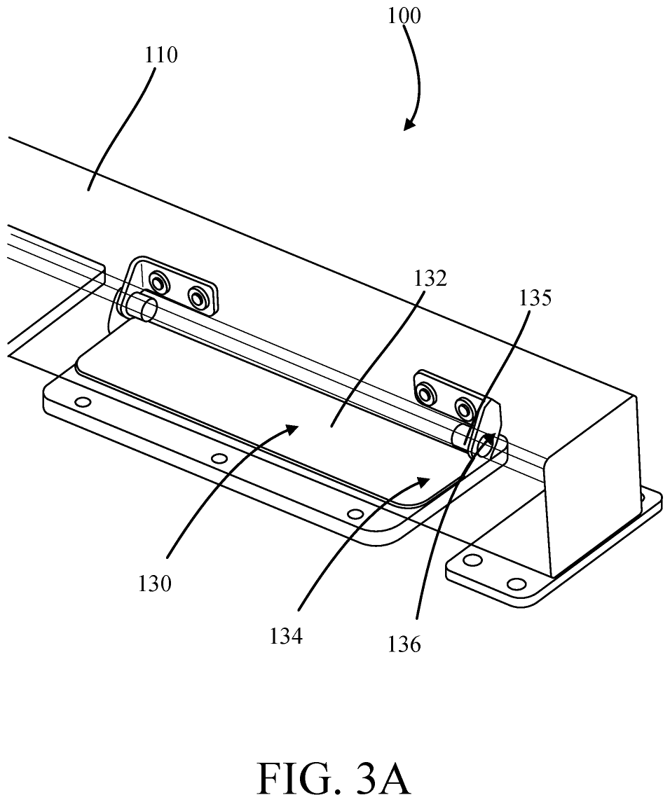

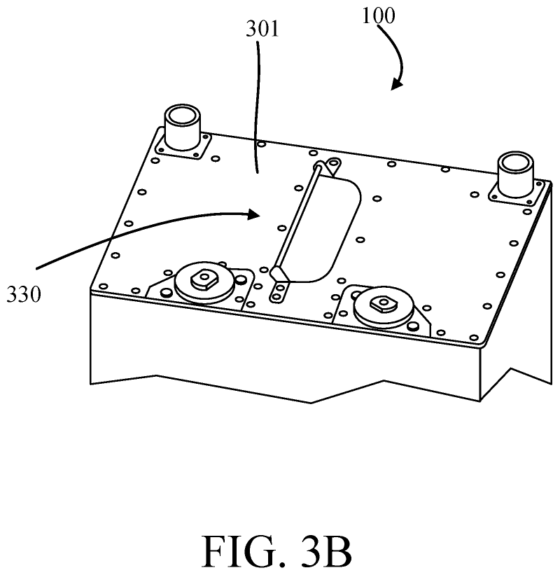

Referring now to FIG. 3A, a perspective view of a gang vent system 100 for use in an interconnected battery system (e.g., interconnected battery system 10 from FIG. 1), is illustrated, in accordance with various embodiments. The gang vent system 100 includes a common vent 110 and a valve assembly 130. A “valve assembly” as disclosed herein refers to a device for controlling the passage of fluid or air through a pipe, duct, etc.” In various embodiments, the valve assembly 130 is configured to seal a fluid port (e.g., vent port 30 or vent port 50) in a plurality of fluid ports (e.g., the plurality of fluid outlets 120 from FIG. 1) of an interconnected battery system 10 from FIG. 1. In this regard, the valve assembly 130 may be configured to be in a closed position during normal operation of the interconnected battery system 10 from FIG. 1, in accordance with various embodiments.

In various embodiments, the valve assembly 130 comprises a bracket 132. In various embodiments the bracket 132 is made of a high-temperature resistant material. For example, the bracket 132 may comprise a stainless steel superalloy, a nickel-based super alloy, or the like. In various embodiments, the bracket 132 may comprise a material with a melting point greater than 900° C. (1652° F.). In this regard, the bracket 132 may be exposed to excessive temperatures (e.g., between 600° C. and 900° C.) during a thermal runaway event (e.g., from a vent port the bracket 132 is sealing or via the common vent 110 from another vent port in the interconnected battery system 10 from FIG. 1).

In various embodiments, the valve assembly 130 further comprises a biasing mechanism 134. The biasing mechanism 134 may be disposed between the common vent 110 and the bracket 132. In various embodiments, the biasing mechanism 134 is configured to bias the bracket in a closed position (i.e., a position to seal a respective vent port (e.g., vent port 30 from FIG. 2A or vent port 50 from FIG. 2B). The biasing mechanism may be any mechanism configured to bias the bracket 132 into a closed position. In various embodiments, the biasing mechanism 134 includes at least one torsional spring (e.g., torsional spring 135). In various embodiments, the biasing mechanism may comprise a compression spring disposed in the common vent 110, an extension spring disposed in an internal cavity (e.g., internal cavity 32 from FIG. 2A or internal cavity 52 from FIG. 2B) of a respective ICBM (e.g., ICBM 20 from FIG. 2A or ICBM 40 from FIG. 2B). In various embodiments, any type of spring may be used as a biasing mechanism. For example, a biasing mechanism may comprise a plurality of magnets configured to bias the valve assembly 130 in a closed position, in accordance with various embodiments. In response to a pressure threshold being exceeded, the valve assembly 130 could become biased in an open position via additional magnets or a ratcheting mechanism as disclosed herein. In various embodiments, by biasing the bracket 132 into a closed position, the biasing mechanism 134 ensures the bracket 132 continues to maintain a seal during normal operation and in the event the common vent 110 is ejecting high-temperature gases and ejecta during a thermal runaway event. In this regard, a respective ICBM (e.g., ICBM 20 from FIG. 2A or ICBM 40 from FIG. 2B) may be shielded from the high-temperature gases and ejecta: thus, preventing propagation of a thermal runaway event to another ICBM in a plurality of ICBMs in an interconnected battery system 10 from FIG. 1, in accordance with various embodiments.

In various embodiments, the valve assembly 130 further comprises a ratcheting mechanism 136. A “ratcheting mechanism” as described herein, refers to a component configured to transition in steps in a steady and irreversible manner. For example, when lower pressure from a thermal runaway event is experienced in an internal cavity of an ICBM (e.g., internal cavity 32 from FIG. 2A or internal cavity 52 from FIG. 2B), the ratcheting mechanism may open the valve assembly slightly. Similarly, as pressure increases, the ratcheting mechanism may open the valve assembly 130 more until a max pressure sets an amount the valve assembly 130 is open. In this regard, by having a ratcheting mechanism 136 as disclosed herein, the valve assembly transition from an open position to a closed position due to back pressure may be prevented. Thus, the ratcheting mechanism 136, in accordance with various embodiments, facilitates quicker venting of an ICBM (e.g., ICBM 20 from FIG. 2A or ICBM 40 from FIG. 2B) in a thermal runway event, which may ultimately eject heat more quickly and eliminate potential for thermal runaway propagation.

Although illustrated as being coupled directly to the common vent 110, the valve assembly 130 is not limited in this regard. For example, with brief reference to FIG. 3B, a valve assembly 330 of a gang vent system 100 may be coupled to a battery module 301 directly (e.g., ICBM 12, 14, 16, 18 from FIG. 1). In this regard, the routing of the common vent 110 from FIG. 3A may have greater flexibility and customizability relative to a system where the valve assembly is coupled to the common vent 110 (e.g., valve assembly 130 from FIG. 3A). In various embodiments, the valve assembly 330 is in accordance with valve assembly 130 as described previously herein with the exception of being coupled to the battery module 301 directly as opposed to the common vent 110, in accordance with various embodiments.

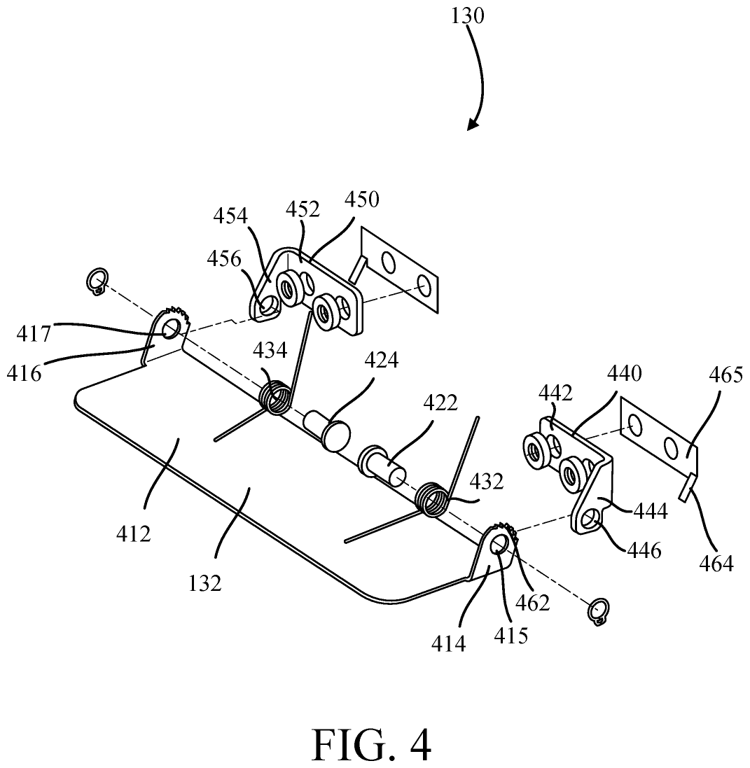

Referring now to FIG. 4, an exploded detailed view of a valve assembly 130 is illustrated, in accordance with various embodiments. The valve assembly 130 may be manufactured from high-temperature components as outlined previously herein (e.g., metallic components with melting temperatures above 900° C. (1652° F.)). In various embodiments, the various components may contribute to a lightweight design by including thin, sheet metal components used in various mechanical applications (e.g., geared towards aerospace applications, or the like). In various embodiments, the various components may be simplistic and cost effective, providing great economics of scale relative to typical venting systems for battery systems. The valve assembly 130 comprises a bracket 132, a biasing mechanism 134, and a ratcheting mechanism 136. Although biasing mechanism 134 and ratcheting mechanism 136 are described with specific elements below, these components are not limited in this regard.

In various embodiments, the bracket 132 comprises a base plate 412, a first flange 414 extending vertically from the base plate 412 on a first side of the base plate 412 and a second flange 416 disposed on a second side of the base plate 412, the second side opposite the first side. In various embodiments, the first flange 414 has an aperture 415 disposed therethrough and the second flange 416 has an aperture 417 disposed therethrough. In various embodiments, the apertures 415, 417 may be co-axial. In this regard, apertures 415, 417 may define an axis of rotation of the bracket 132. Although illustrated as bracket 132 being pivotably coupled to a respective common vent 110 from FIGS. 1, 3, the present disclosure is not limited in this regard. For example, bracket 132 may be slidingly coupled (e.g., configure to translate vertically or horizontally) and still be within the scope of this disclosure. In various embodiments, by pivotably coupling bracket 132 to a common vent 110 from FIG. 3A, the valve assembly 130 may include fewer components and lighter weight relative to alternative embodiments.

In various embodiments, the valve assembly 130 further comprises a first shaft 422 and a second shaft 424. Although illustrated as including two shafts, the present disclosure is not limited in this regard. For example, a single shaft could extend through the apertures 415, 417 and still be within the scope of this disclosure (e.g., as illustrated in valve assembly 330 of FIG. 3B). In various embodiments, the first shaft 422 may operably couple a first torsion spring 432 to the first flange 414, and the second shaft 424 may operably couple a second torsion spring 434 to the second flange 416. In various embodiments, the biasing mechanism 134 comprises the first torsion spring 432 and the second torsion spring 434 (i.e., the first torsion spring 432 and the second torsion spring 434 are configured to bias the bracket 132 into a closed position). Moreover, any suitable number of biasing springs may be used as appropriate.

In various embodiments, the valve assembly 130 further comprises mounting brackets 440, 450 configured to mount to a common vent (e.g., common vent 110 from FIGS. 1, 3). In this regard, mounting brackets 440, 450 each comprise a mounting plate 442, 452 and a flange 444, 454 extending away from the mounting plate 442, 452. In various embodiments, the flange 444, 454 may comprise an aperture 446, 456 disposed therethrough. Thus, the bracket 132 may be pivotably coupled to the mounting brackets 440, 450 via extending the shafts 422, 424, through the apertures 446, 456 of the flanges 444, 454 and the apertures 415, 417 of the flanges 414, 416 of the bracket 132, in accordance with various embodiments.

In various embodiments, the ratcheting mechanism 136 comprises a gear 462 and a pawl 464. The gear 462 may be an element of flange 414 and/or flange 416, in accordance with various embodiments. The pawl 464 may be coupled as a distinct component to mounting bracket 440 and/or mounting bracket 450. In this regard, pawl 464 may extend from a spacer 465 and be configured to interface with pawl 464 during normal operation of the interconnected battery system 10 from FIG. 1. Although illustrated as comprising a separate distinct component, pawl 464 is not limited in this regard. For example, pawl 464 may be integral with mounting bracket 440 and/or mounting bracket 450, in accordance with various embodiments. For example, a pin like feature may extend outward from flange 444 and interface with gear 462, in accordance with various embodiments.

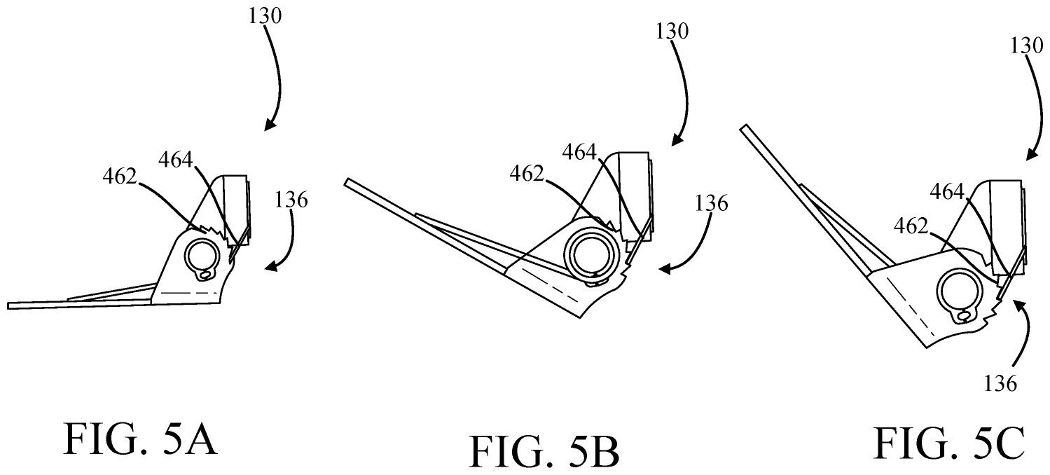

Referring now to FIGS. 5A-C, a side view of a valve assembly 130 in normal operation (FIG. 5A), in a medium pressure position (FIG. 5B) and in a high pressure position (FIG. 5C) are illustrated, in accordance with various embodiments. In various embodiments, the gear 462 contains various steps around a perimeter of flange 414 and/or flange 416 from FIG. 4. In various embodiments, as pressure increases, the bracket 132 may rotate enough to move from one step of gear 462 to a next step of gear 462. In this regard, once pressure increases enough to push base plate upward enough to move from one step of gear 462 to a next step of gear 462, the valve assembly cannot close again (i.e., an opening is maintained at a valve interface). In various embodiments, once initial locking occurs (i.e., once the pawl 464 interfaces with a second step of the gear 462), the valve assembly 130 remains open, eliminating back pressure on the bracket 132 from the torsional spring(s). In this regard, locking positions of ratcheting mechanism 136 may be fined tuned based on a specific application based on expected pressures from thermal runaway events and/or other defined features of an ICBM (e.g., ICBM 20 from FIG. 2A or ICBM 40 from FIG. 2B).

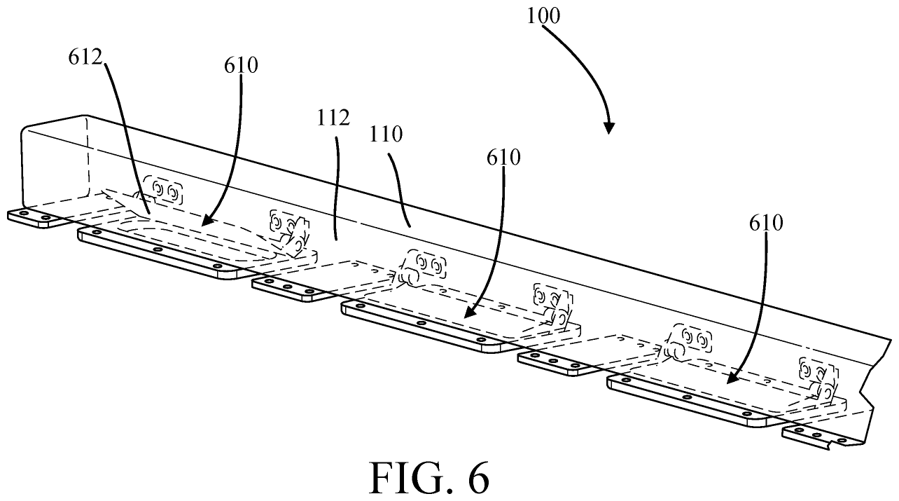

Referring now to FIG. 6, a perspective view of a portion of a gang vent system 100 during a thermal runaway event of in an ICBM of an interconnected battery system is illustrated, in accordance with various embodiments. The gang vent system 100 includes the common vent 110 and a plurality of valve assemblies 610. Each valve assembly in the plurality of valve assemblies is in accordance with valve assembly 130 from FIGS. 3-5C. In this regard, by having a common valve assembly 130 across the gang vent system, economies of scale may be reduced and/or simplicity maintained, in accordance with various embodiments.

In various embodiments, the common vent 110 comprises a fluid conduit 112. In various embodiments, the fluid conduit is in fluid communication with a vent outlet (e.g., an exhaust for gang vent system 100). In various embodiments, in response to an ICBM in a plurality of ICBMs of an interconnected battery system 10 from FIG. 1 entering thermal runaway, a respective valve assembly 612 in the plurality of valve assembly 610 is ratcheted open creating a fluid inlet to the fluid conduit 112 of the common vent 110. In this regard, gases, ejecta, and/or FOD may be expelled efficiently and effectively. In various embodiments, a remainder of ICBMs in the plurality of ICBMs of the interconnected battery system 10 from FIG. 1 may remain sealed via a remainder of valve assemblies in the plurality of valve assemblies 610 during the thermal runaway event. In this regard, the gang vent system 100 may facilitate efficient expulsion of heat from the thermal runaway event and prevent thermal runaway propagation to any of a remainder of the plurality of ICMBs, in accordance with various embodiments. In various embodiments, the common vent 110 comprises a distinct, independent component of the interconnected battery system 10 from FIG. 1 (i.e., the common vent 110 may be customizable based on a number of ICBMs in a respective interconnected battery system 10 from FIG. 1).

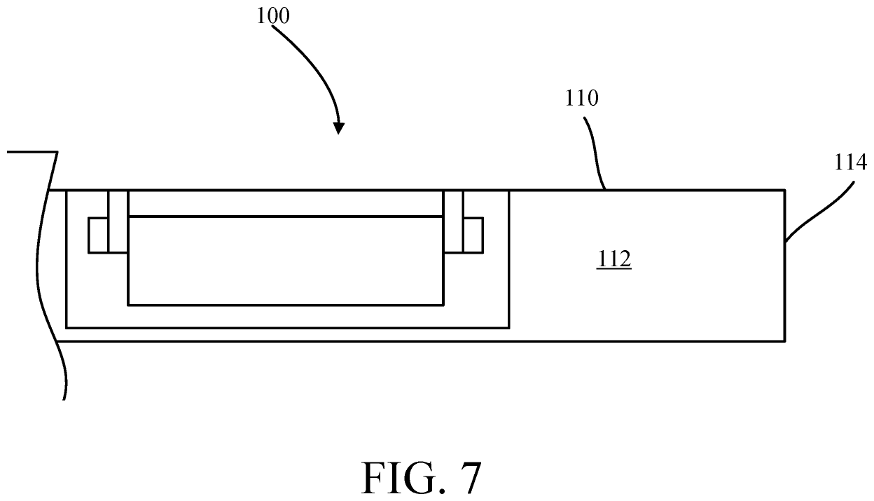

Referring now to FIG. 7, a cross-sectional view of a portion of a gang vent system 100 illustrated, in accordance with various embodiments. The gang vent system 100 comprises the common vent 110 defining the conduit 112. In various embodiments, the common vent 110 is terminated in vent outlet 114 (i.e., a common vent out). In this regard, each ICBM in the interconnected battery system 10 from FIG. 1 may have a common vent outlet (e.g., vent outlet 114). In this regard, venting of the common vent 110 may result in a common outlet for the interconnected battery system 10 from FIG. 1, resulting in fewer components, in accordance with various embodiments. In various embodiments, the vent outlet 114 may be disposed external to the battery system 10 from FIG. 1. In various embodiments, the vent outlet 114 may be disposed external to an external structure utilizing the battery system (i.e., external to an aircraft or the like). In various embodiments, the vent outlet may exhaust ejecta or the like from a thermal runaway event of an ICBM in the interconnected battery system 10 from FIG. 1 to an external environment proximate ambient air.

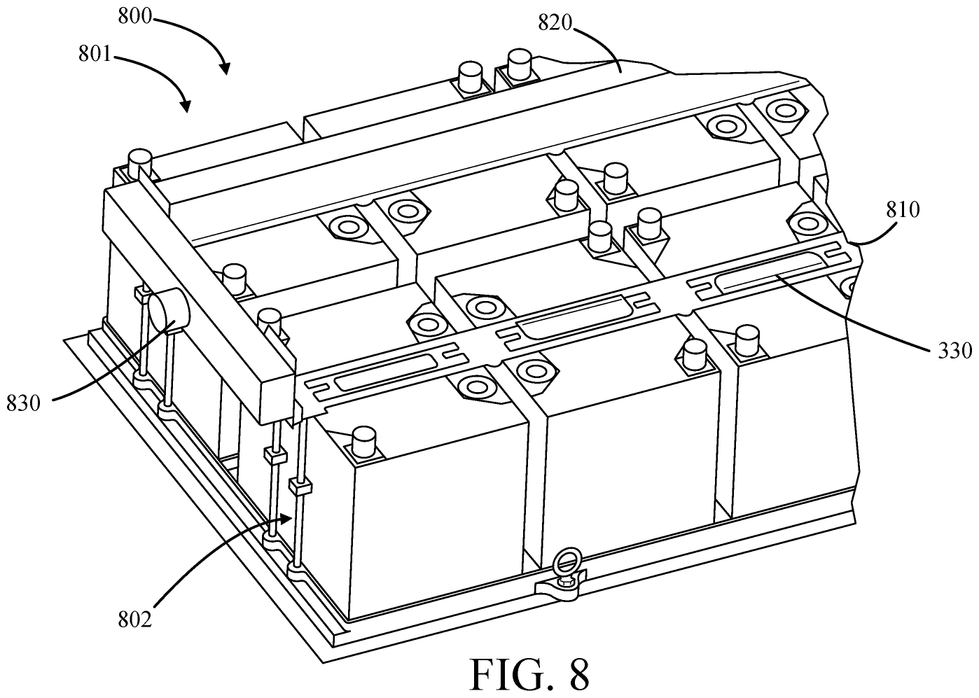

Referring now to FIG. 8, a portion of a battery system 800 having a gang vent system 801 is illustrated, in accordance with various embodiments. In various embodiments, the battery system 800 is in accordance with battery system 10 from FIG. 1 except as otherwise disclosed herein. In various embodiments, the common vent 110 comprises a plate 810 configured to interface with each battery module in a row of battery modules 802. The plate 810 may be configured to ensure the conduit defined by the common vent 110 maintains a seal from the external environment over a gap between adjacent battery modules in the row of battery modules 802. In various embodiments, the common vent 110 further comprises a shroud 820 configured to mount to the plate 810 and the row of battery modules 802, in accordance with various embodiments. In various embodiments, the gang vent system 100 comprises a single vent outlet 830. In various embodiments, each module in the plurality of modules of battery system 800 may be configured to be in fluid communication with the single vent outlet 830 in response to a cell in the respective module entering thermal runaway and generating a pressure configured to open a valve assembly 330.

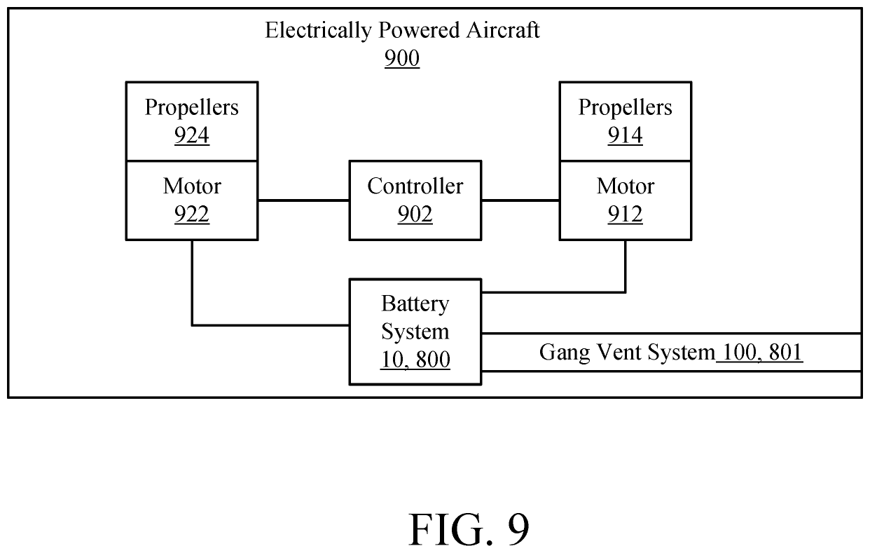

Referring to FIG. 9, a schematic view of an electrically powered aircraft 900 having a battery system 10, 800 with a gang vent system 100, 801 is illustrated, in accordance with various embodiments. In various embodiments, the electrically powered aircraft 900 comprises a controller 902, motors 912, 922, and propellers 914, 924. Each motor 912, 922 is operably coupled to a respective propeller 914, 924. Each motor 912, 922 is electrically coupled to the battery system 10, 800. In this regard, the battery system 10, 800 is configured to power the motors 912, 922 to drive the respective propellers 914, 924 and power the electrically powered aircraft 900, in accordance with various embodiments. In various embodiments, the controller 902 is configured to command the motors 912, 922 to pull power from the battery system 10, 800 during operation of the electrically powered aircraft 900. Although disclosed herein as being configured for an aircraft, the present disclosure is not limited in this regard. For example, the battery system 10, 800 could be used in other electric vehicles, such as electric cars, electric trucks, electric boats, or the like.

In various embodiments, the battery system 10, 800 may be configured for use on an aircraft (e.g., electrically powered aircraft 900). A battery system 10, 800, for purposes of this disclosure, includes a plurality of electrically connected cells (e.g., cell-brick assemblies, pouch cells, or the like), as disclosed previously herein. These electrically connected cells may, in turn, include a parallel, series, or combination of both, collection of electrochemical or electrostatic cells hereafter referred to collectively as “cells”, that can be charged electrically to provide a static potential for power or released electrical charge when needed. When cells are assembled into a battery system 10, 800, the cells are often linked together through metal strips, straps, wires, bus bars, etc., that are welded, soldered, or otherwise fastened to each cell to link them together in the desired configuration.

In various embodiments, the controller 902 is in operable communication (e.g., wireless or wired) with a motors 912, 922. In various embodiments, controller 902 may be configured as a central network element or hub to access various systems and components of the electrically powered aircraft 900. Controller 902 may comprise a network, computer-based system, and/or software components configured to provide an access point to various systems and components of the electrically powered aircraft 900. In various embodiments, controller 902 may comprise a processor. In various embodiments, controller 902 may be implemented in a single processor. In various embodiments, controller 902 may be implemented as and may include one or more processors and/or one or more tangible, non-transitory memories and be capable of implementing logic. Each processor can be a general purpose processor, a digital signal processor (“DSP”), an application specific integrated circuit (“ASIC”), a field programable gate array (“FPGA”) or other programable logic device, discrete gate or transistor logic, discrete hardware components, or any combination thereof. Controller 902 may comprise a processor configured to implement various logical operations in response to execution of instructions, for example, instructions stored on a non-transitory, tangible, computer-readable medium configured to communicate with controller 902.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

We claim:

1. A gang vent system for a battery system, the gang vent system comprising:
a common vent defining a fluid conduit; and
a plurality of valve assemblies disposed in the common vent, each valve in the plurality of valve assemblies configured to fluidly seal the fluid conduit from an internal cavity of a housing of a battery module in the battery system during normal operation of the battery system and define a closed position, each valve assembly in the plurality of valve assemblies biased into the closed position.

2. The gang vent system of claim 1, wherein the common vent comprises a vent outlet.

3. The gang vent system of claim 2, wherein a valve assembly in the plurality of valve assemblies is configured to open in response thermal runaway occurring in a cell in the battery module.

4. The gang vent system of claim 3, wherein a remainder of valve assemblies in the plurality of valve assemblies are configured to maintain a seal while gases are exhausted through the valve assembly, the common vent, and the vent outlet.

5. The gang vent system of claim 1, further comprising a plurality of battery modules, each battery module in the plurality of battery modules comprising a vent port and a plurality of cells disposed in the internal cavity, wherein the vent port is sealed by a respective valve assembly in the plurality of valve assemblies during operation of the battery system.

6. The gang vent system of claim 1, wherein each valve assembly in the plurality of valve assemblies comprises a bracket pivotably coupled to the common vent, a biasing mechanism, each valve assembly in the plurality of valve assemblies configured to transition in steps in a steady and irreversible manner.

7. The gang vent system of claim 6, wherein each valve assembly in the plurality of valve assemblies comprises a mounting bracket coupled to a battery module in a plurality of battery modules, the bracket pivotably coupled to the mounting bracket.

8. The gang vent system of claim 7, wherein each valve in the plurality of valve assemblies comprises a ratcheting mechanism including a gear and a pawl.

9. The gang vent system of claim 8, wherein the gear of the ratcheting mechanism is disposed on a flange of the bracket, and wherein the pawl of the ratcheting mechanism is coupled to the mounting bracket.

10. A battery system, comprising:
a first battery module having a first plurality of cells disposed in a first internal cavity of a first housing, the first housing defining a first vent port;
a second battery module having a second plurality of cells disposed in a second internal cavity of a second housing, the second housing defining a second vent port;
a third battery module having a third plurality of cells disposed in a third internal cavity of a third housing, the third housing defining a third vent port, wherein the first battery module, the second battery module, and the third battery module are in electrical communication;
a first valve assembly configured to seal the first vent port during normal operation of the battery system;
a second valve assembly configured to seal the second vent port during normal operation of the battery system;
a third valve assembly configured to seal the third vent port during normal operation of the battery system; and
a common vent having the first valve assembly, the second valve assembly, and the third valve assembly disposed therein.

11. The battery system of claim 10, wherein the first valve assembly is configured open in response to thermal runaway occurring in a cell in the first plurality of cells and a pressure being created that opens the first valve assembly.

12. The battery system of claim 11, wherein the second valve assembly and the third valve assembly are configured to isolate an exhaust flow from the second internal cavity and the third internal cavity, and wherein the exhaust flow travels from the first internal cavity through the common vent and out an exhaust outlet.

13. The battery system of claim 10, wherein the first valve assembly, the second valve assembly, and the third valve assembly each are configured to transition in steps in a steady and irreversible manner.

14. The battery system of claim 13, wherein the first valve assembly, the second valve assembly, and the third valve assembly each comprise a bracket, a biasing mechanism, and a ratcheting mechanism, and wherein the ratcheting mechanism comprises a gear and a pawl.

15. The battery system of claim 14, wherein the gear is disposed on a flange of the bracket and the pawl mechanically engages with the gear.

16. A method of gang venting a battery system, the method comprising:
opening a valve assembly in a plurality of valve assemblies from a closed position to an open position in response to building pressure in an internal cavity of a first battery module, the internal cavity being fluidly coupled to a common vent in response to opening the valve assembly;
exhausting gases from the internal cavity and through the common vent; and
maintaining a seal between a remainder of valve assemblies in the plurality of valve assemblies during the exhausting gases from the internal cavity.

17. The method of claim 16, where the seal is maintained between a fluid conduit defined by the common vent and each internal cavity of each battery module in a plurality of battery modules, the plurality of battery modules excluding the first battery module.

18. The method of claim 16, wherein opening the valve assembly further comprises transitioning the valve assembly from a first position to a second position in response to experiencing a first pressure.

19. The method of claim 18, wherein opening the valve assembly further comprises transitioning the valve assembly from the second position to a third position in response to experiencing a second pressure, the second pressure being greater than the first pressure.

20. The method of claim 19, wherein the second position has a greater opening volume compared to the first position.
